(19) United States
(12) Patent Application Publication
(10) Pub. No.: US 2016/0307239 A1
(43) Pub. Date: Oct. 20, 2016

(54) GENERATION APPARATUS, GENERATION METHOD, AND NON-TRANSITORY COMPUTER READABLE STORAGE MEDIUM

(71) Applicant: YAHOO JAPAN CORPORATION, Tokyo (JP)

(72) Inventors: Ikuno NAKANISHI, Tokyo (JP); Takumi NIMAIDA, Tokyo (JP)

(73) Assignee: YAHOO JAPAN CORPORATION, Tokyo (JP)

(21) Appl. No.: 15/056,576

(22) Filed: Feb. 29, 2016

(30) Foreign Application Priority Data
Apr. 20, 2015 (JP) 2015-086206

(51) Int. Cl. G06Q 30/02; G06F 17/30

(52) U.S. Cl. CPC G06Q 30/0276; G06F 17/30247

(57) ABSTRACT

A generation apparatus includes an acquiring unit that acquires a first content to he displayed in a display area included in a predetermined content, and a second content that is provided by a provider different from a provider of the first content. The generation apparatus includes a generating unit that generates a third content, in which the first content and the second content arc superimposed such that at least a part of the second content is visible.

### CROSS-REFERENCE TO RELATED APPLICATIONS

The present application claims priority to and incorporates by reference the entire contents of Japanese Patent Application No. 2015-086206 filed in Japan on Apr. 20, 2015.

### BACKGROUND OF THE INVENTION

1. Field of the Invention

The present invention relates to a generation apparatus, a generation method, and a non-transitory computer readable storage medium.

2. Description of the Related Art

Conventionally, there has been proposed a technology for displaying various kinds of information on arbitrary information display apparatuses including smart devices, such an smartphones or tablet personal computers (PCs), desktop PCs, and the like. As an example of the technology, there has been proposed a technology for displaying a, content different from a web page when the web page is displayed and attracting interest of a user who views the web page to the content. For example, as a technology for distributing the content as described above, there has been proposed a technology for generating an advertisement content in which a predetermined thumbnail image is inserted in a text advertisement that advertises a company, a product, or the like, and displaying the generated advertisement content together with the web page.

Patent Document 1: Japanese National Publication of International Patent Application No. 2009-54776

Non-Patent Document 1: “Automatic Image Extensions for GDN Text”, [online], [searched on Apr. 9, 2015], Internet <http://sem-labo.net/blog/2014/04/17/0933/>

However, in the conventional technology as described above, in some cases, an appeal effect of information related to the content is not always high. For example, in the conventional advertisement content, a text advertisement and a thumbnail image are displayed independent of each other. Therefore, it is not always possible to generate a content with a higher appeal effect relative to the text advertisement.

### SUMMARY OF THE INVENTION

It is an object of the present invention to at least partially solve the problems in the conventional technology.

According to one aspect of an embodiment, a generation apparatus includes an acquiring unit that acquires a first content to be displayed in a display area included in a predetermined content, and a second content that is provided by a provider different from a provider of the first content. The generation apparatus includes a generating unit that generates a third content, in which the first content and the second content are superimposed such that at least a part of the second content is visible.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an example of a generation process according to an embodiment;

FIG. 2 is a diagram illustrating an example of a functional configuration of an advertisement distribution server according to the embodiment;

FIG. 3 is a diagram illustrating an example of information registered in an advertisement database according to the embodiment;

FIG. 4 is a diagram illustrating an example of a functional configuration of an image distribution server. according to the embodiment;

FIG. 5 is a diagram illustrating an example of information registered in an image database according to the embodiment;

FIG. 6 is a diagram illustrating an example of a functional configuration of an advertisement generation server according to the embodiment;

FIG. 7 is a diagram illustrating an example of information registered in a format database according to the embodiment;

FIG. 8 is a diagram illustrating an example of information registered in a distribution record database according to the embodiment;

FIG. 9 is a diagram illustrating other examples of an advertisement content generated by the advertisement generation server according to the embodiment;

FIG. 10 is a sequence diagram illustrating an example of a generation process performed by an advertisement generation system according to the embodiment;

FIG. 11 is a flowchart illustrating an example of the flow of the process performed by the advertisement generation server according to the embodiment;

FIG. 12 is a diagram illustrating an example of a hardware configuration of a computer that implements functions of the advertisement generation server.

### DETAILED DESCRIPTION OF THE PREFERRED EMBODIMENTS

Modes (hereinafter, referred to as “embodiments”) for carrying out a generation apparatus, a generation method, and a non-transitory computer readable storage medium according to the present application will be described in detail below with reference to the drawings. The generation apparatus, the generation method, and the non-transitory computer readable storage medium of the present application are not limited by the embodiments. In each of the embodiments below, the same components will be denoted by the same reference numerals and symbols, and description thereof will be omitted.

1. Generation Process

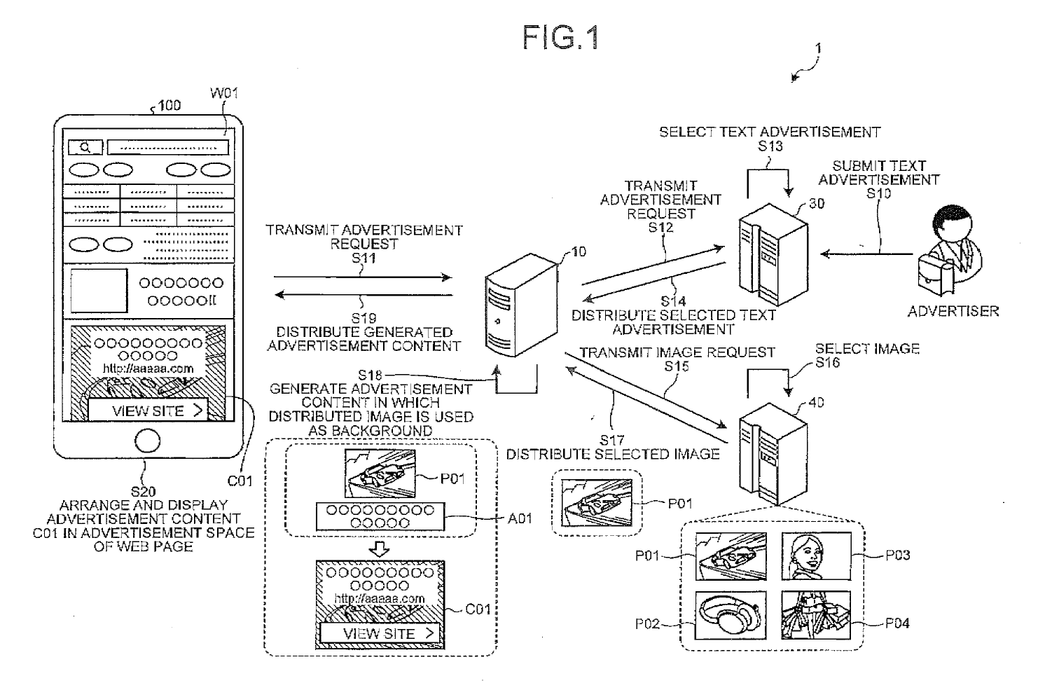

An example of a generation process according to the embodiment will be described below with reference to FIG. 1. FIG. 1 is diagram illustrating an example of the generation process according to the embodiment. In FIG. 1, a process of generating an advertisement content as a content related to an advertisement is illustrated as one example of the generation process by using an advertisement generation system 1 as an example. Specifically, FIG. 1 illustrates a case in which an advertisement generation server 10 included in the advertisement generation system 1 performs a process of generating a new advertisement content by combining a content including text related to an advertisement (hereinafter, described as a text advertisement) and an image related to the content of the text in a predetermined format.

It is assumed that the advertisement content is not only a commercial or non-commercial advertisement, but also recruitment of volunteers, a public service advertisement, a notification to the public, a part of information related to a web page, or any other arbitrary content. That is, the advertisement generation server 10 can apply not only a content including so-called advertisement related information, but also an image, a moving image, a character, a graphic, a symbol, a hyper link, or any other arbitrary content as long as the content attracts interest of a user and widely spreads information contained in the content or information contained in a different content related to the content.

Furthermore, the advertisement generation server 10 may generate an advertisement content in which text and a moving image are combined. Moreover, each content, such as text or an image, combined by the advertisement generation server 10 need, not be a content related to an advertisement. That is, each content may be a content that does not achieve a .function as the advertisement content before being combined, as long as the content can achieve the function as the advertisement content by being combined.

As illustrated in FIG. 1, the advertisement generation system 1 includes the advertisement generation server 10, an advertisement distribution server 30, an image distribution server 40, and a terminal device 100. The advertisement generation server 10 is communicably connected to the advertisement distribution server 50, the image distribution server 40, and the terminal device 100 via a network (for example, the Internet) (not illustrated). The numbers of the terminal devices 100, the advertisement distribution servers 30, and the image distribution servers 40 included in the advertisement generation system I are not limited by the numbers illustrated in FIG. 1.

The terminal device 100 is an information processing apparatus used by a user, and is used to view a content, such as a web page, by the user. For example, the terminal device 100 is a mobile terminal such as a smartphone, a tablet terminal, or a personal digital assistant (PDA), a desktop C, a notebook PC, or the like.

In the example illustrated in FIG. 1, the terminal device 100 displays a web page W01. The web page W01 is a web page in which, for example, news, a weather forecast, an index or a content of received mail, a photo viewer, and various other contents are arranged, and which is described in a hyper text markup language (HTML), an extensible markup language (XML), or the like.

In the web page W01, a display area for displaying an advertisement content is set, and a command is embedded to transmit, to the advertisement generation server 10, an advertisement request as a request for distribution of an advertisement content in order to display the advertisement content in the display area. To display the web page W01 as described above, the terminal device 100 transmits, to the advertisement generation server 10, an advertisement request as a request for distribution of a text advertisement. Upon receiving the advertisement content from the advertisement generation server 10, the terminal device 100 arranges the received advertisement content in the display area of the web page W01 to display the web page W01 and the advertisement content.

The advertisement distribution server 30 is a server device that distributes a text advertisement registered by an advertiser. Specifically, the advertisement distribution server 30 accepts submissions of text advertisements from advertisers, and stores the accepted teat advertisements. Upon accepting an advertisement request as a request for distribution of an advertisement, the advertisement distribution server 30 selects a text advertisement to be a distribution target, and distributes the selected text advertisement to a transmission source of the request.

The image distribution server 40 is a server device that provides an image to a person who requests to use the image. Specifically, the image distribution server 40 accepts contributions of images from image contributors, and stores the accepted images. The image distribution server 40 accepts a request related to acquisition of an image from a person who requests to use an image stored in the image distribution server 40. The image distribution server 40 extracts an appropriate image corresponding to the request, and distributes the extracted image to the transmission source of the request.

The advertisement generation server 10 is a server device that, upon receiving the advertisement request from the terminal device 100, performs a generation process of generating an advertisement content in which a text advertisement and an image are combined, and distributes the generated advertisement content to the terminal device 100. Specifically, the advertisement generation server 10 generates a new advertisement content to be distributed to the terminal device 100 by combining a text advertisement that an advertiser has submitted to the advertisement distribution server 30 and an image provided by the image distribution server 40. The generation process performed by the advertisement generation system 1 will be described below in accordance with the flow illustrated in FIG. 1.

In the example illustrated in FIG. 1, the advertisement distribution server 30 accepts submission of a text advertisement, as a target to be displayed in an advertisement space included in a web page, from an advertiser who requests distribution of the text advertisement (Step S10). The advertisement distribution server 30 stores the submitted text advertisement. Then, the advertisement distribution server 20 waits until an advertisement request is accepted

The terminal device 100 accesses a predetermined web server (not illustrated) and acquires the web page W01. The terminal device 100 transmits an advertisement request to the advertisement generation server 10 in accordance with the command embedded in the web page W01 (Step S11), The advertisement request is realized by, for example, a hypertext transfer protocol (HTTP) request described in the HTML or the XML. Furthermore, to improve an appeal effect of information related to the advertisement content, the terminal device 100 transmits, as a keyword, various kinds of information useful for selecting an advertisement content, that is, information (for example, age, gender, or the like) on the user of the terminal device 100, information on the web page W01, or the like, together with the advertisement request.

Upon receiving the advertisement request and the keyword from the terminal device 100, the advertisement generation server 10 transmits, to the advertisement distribution server 30, an advertisement request to request distribution of a text advertisement and the keyword received from the terminal device 100 (Step 012). Upon receiving the advertisement request and the keyword from the advertisement generation server 10, the advertisement distribution server 30 selects a text advertisement to be a distribution target in accordance with the received keyword (Step S13). For example, upon receiving a keyword indicating that the gender of the user is male in his 30's, the advertisement distribution server 30 selects a text advertisement for which men in their 30's are set as distribution targets. The advertisement distribution server 30 distributes the selected text advertisement to the advertisement generation server 10 (Step S14).

Subsequently(the advertisement generation server 10 transmits an image request as a request for distribution of an image and a keyword for selecting an image to the image distribution server 40 in order to acquire an image to be combined with the text advertisement (Step S15). It is assumed here that the keyword for selecting an image includes information on the text advertisement distributed at Step S14, that is, information on the text advertisement to be composited with the image, in addition to the information on the user of the terminal device 100 and the information on the web page W01. For example, the information on the text advertisement includes information such as a type of a product related to the text advertisement or characteristics of the user to whom the text advertisement is distributed.

Upon receiving the image request and the keyword, the image distribution server 40 selects an image that matches the received keyword from among registered images (Step S16), and distributes the selected image to the advertisement generation server 10 (Step S17). For example, in the example illustrated in FIG. 1, it is assumed that an image P01 in which a car is pictured, an image P02 in which headphones are pictured, an image 203 in which a woman is pictured, and an image P04 in which a person who is doing shopping is pictured are registered in the image distribution server 40. In this case, upon receiving a keyword indicating that the selected text advertisement is an advertisement targeted to men or an advertisement related to a car, the image distribution server 40 selects the image P01 in which the car is pictured. Then, the image distribution server 40 distributes the selected image P01 to the advertisement generation server 10.

As described above, the advertisement generation server 10 that has accepted distribution of a text advertisement and an image performs a process of generating an advertisement content in which the received text advertisement and the received image are composited. More specifically, the advertisement generation server 10 generates an advertisement content, in which the received image is arranged behind the text advertisement, that is, in which the received text advertisement is superimposed on the received image used as a background image (Step S18).

If the image is arranged as it is behind the text advertisement, the visibility of the text advertisement may be reduced. Tor example, if a background image and a text advertisement with the same type of color tone are composited, or if a background image and a text advertisement with high contrast ratios are composited, the visibility of the text advertisement is reduced. Therefore, the advertisement generation server 10 generates an advertisement content in which the background image and the text are composited such that the visibility of the background imago is reduced relative to the visibility of the text advertisement.

For example, the advertisement generation server 10 reduces the visibility of the background image relative to the visibility of the text advertisement by using at image composition method for reducing the contrast ratio of a distributed image to below a predetermined threshold or for arranging an monochrome image that has a color different from the color of text included in the text advertisement and that has predetermined transparency. Then, the advertisement generation server 10 generates an advertisement content in which the distributed text advertisement is arranged in front of the background image with the reduced visibility.

In the example illustrated in FIG. 1, the advertisement generation server 10 reduces the contrast ratio of the entire image P01, and generates a background image in which the color tone of an area behind the text advertisement is adjusted to a color close to white. Then, the advertisement generation server 10 generates an advertisement content C01, in which the color of a text advertisement A01 distributed from the advertisement distribution server 30 is set to black and the text advertisement A01 is superimposed on the front of the background image. Furthermore, the advertisement generation server 10 sets, in the entire advertisement content C01, a link to a landing page set for the text advertisement A01, and arranges display objects, such as a uniform resource locator (URL) of a link destination or “view site”.

Subsequently, the advertisement generation server 10 distributes the generated advertisement content C01 to the terminal device 100 (Step S19). The terminal device 100 arranges and displays the distributed advertisement content C01 in the advertisement space of the web page W01 (step S20).

As described above, the advertisement generation server 10 generates an advertisement content in which an image is arranged behind a text advertisement, and distributes the generated advertisement content. Consequently, the advertisement generation server 10 can distribute an advertisement content that is likely to attract attention of a user, that is, an advertisement content with a high appeal effect of information, as compared to the case where a text advertisement is simply distributed.

For example, the advertisement content C01 generated by the advertisement generation server 10 is formed by arranging the image P01 as a background image of the text advertisement A01, and therefore can be viewed as a single new advertisement content as a whole. A content in which text and an image are combined is more likely to attract attention of a user and improve the appeal effect of information as compared to the single text advertisement A01 or the single image P01. Therefore, the advertisement generation server 10 can improve the appeal effect of information related to the text advertisement A01 by generating and distributing the advertisement content C01 in which the text advertisement A01 is superimposed on the image P01.

Furthermore, the advertisement generation server 10 makes a composition of the image P01 and the text advertisement A01 by reducing the visibility of the image P01 relative to the visibility of the text advertisement A01. Therefore, the advertisement generation server 10 can prevent a reduction in the visibility of the text advertisement A01 due to the composition, so that it is possible to improve the appeal effect of the information related to the text advertisement A01.

2. Variations of Compositions

The images registered in the image distribution server 40 include not only an image in which a main object is arranged on the front of an image, but also an image in which a distribution of a feature amount is biased, such as an image in which an object is unevenly arranged in one part of an image. For example, in the image P01 illustrated in FIG. 1, a vehicle as an object is arranged in the entire screen, so that it is possible to assume that the feature amount is uniformly distributed in the entire image. Furthermore, in the image P02, a main-body part of headphones as an object is arranged in the right half of the image, so that it is possible to assume that the feature amount is biased toward the right side of the image. Moreover, in the image P03, the face of a person as an object is arranged in the left half of the image, so that it is possible to assume that the feature amount is biased toward the left side of the image. Furthermore, in the image P04, a plurality of objects, such as a person and bags, are arranged in the lower half of the image, so that it is possible to assume that the feature amount is biased toward the lower side of the image.

If a text advertisement is arranged in a range including a large feature amount as described above, the visibility of the test advertisement may be reduced. Therefore, it is preferable that the advertisement generation server 10 generates an advertisement content in which a text advertisement is arranged so as to avoid the range including the large feature amount in an image. In contrast, when the appeal effect of information is taken into account, and if a distribution of the feature amount of an image is biased, it is preferable to display the image without reducing the visibility of the range including the large feature amount of the image, rather than simply reducing the visibility of the entire image.

Therefore, the advertisement generation server 10 analyzes a distribution of the feature amount of a distributed image. Furthermore, if the distribution of the feature amount is biased, the advertisement generation server 10 specifies, as an area on which a text advertisement is superimposed, an area including a smaller feature amount than those of other areas. Then, the advertisement generation server 10 superimposes the text advertisement on the specified area in the image.

Furthermore, the advertisement generation server 10 reduces the visibility of the area on which the text advertisement is superimposed in the image. For example, if the text advertisement is superimposed on the right half area of the image, the advertisement generation server 10 reduces the visibility of this area. As described above, the advertisement generation server 10 generates an advertisement content in which the visibility of an area with a smaller feature amount than those of the other areas is reduced and the text advertisement is superimposed on this area in a distributed image. Consequently, it is possible to improve the appeal effect of the information related to the advertisement content.

3. Configuration of Advertisement Distribution Server

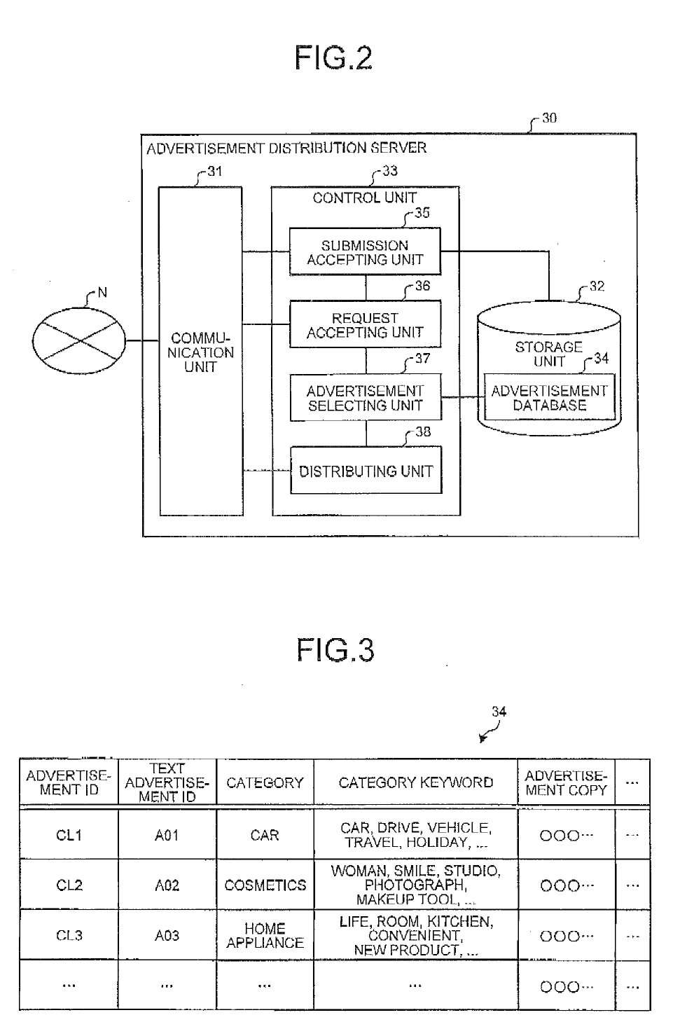

A configuration of the advertisement distribution server 30 according to the embodiment will be described below with reference to FIG. 2. FIG. 2 is a diagram illustrating an example of a functional configuration of the advertisement distribution server according to the embodiment. As illustrated in FIG. 2, the advertisement distribution server 30 includes a communication unit 31, a storage unit 32, and a control unit 33. The communication unit 31 is implemented by, for example, a network interface card (NIC) or the like. The communication unit 31 is connected to a network N by wire or wireless, and performs transmission and reception of information with the terminal device 100 and the advertisement generation server 10.

The storage unit 32 is implemented by, for example, a semiconductor memory device, such as a random access memory (RAM) or a flash memory, or a storage device, such as a hard disk or an optical disk. The storage unit 32 stores therein an advertisement database 34 as a database in which various kinds of information related to a text advertisement submitted from an advertiser are stored.

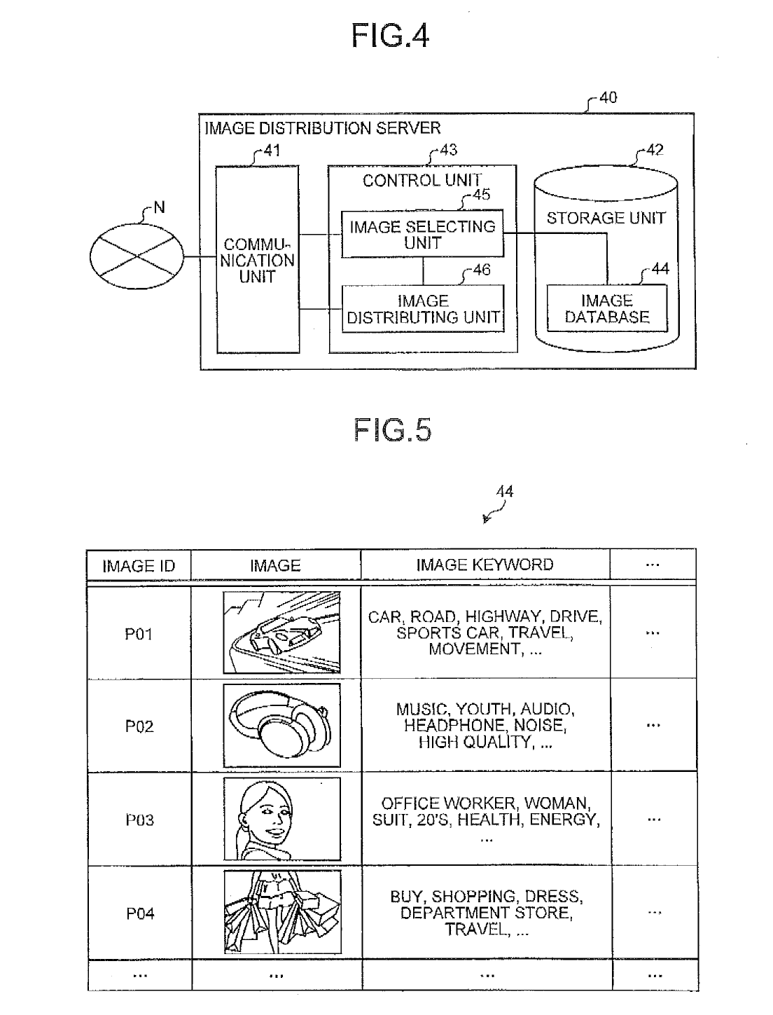

The advertisement database 34 stores therein information related to a text advertisement submitted from an advertiser. For example, FIG. 3 is a diagram illustrating an example of information registered in the advertisement database according to the embodiment. As illustrated in FIG. 3, the advertisement database 34 includes items such as “advertiser ID”, “text advertisement ID”, “category”, “category keyword”, and “advertisement copy”.

The “advertiser ID” is identification information for identifying an advertiser who submits a text advertisement to the advertisement distribution server 30. The “text advertisement ID” is identification information for identifying a text advertisement submitted from an advertiser. In the following, the identification information stored in the text advertisement ID illustrated in FIG. 3 may he used as a reference symbol of the advertisement content. That is, a text advertisement identified by a text advertisement ID “A01” may be described as the “text advertisement A01”.

The “category” indicates a category to which a text advertisement submitted from an advertiser belongs. The category is assigned in accordance with a content to be advertised by the text advertisement, a business type of the advertiser who has submitted the text advertisement, information on a user to which the text advertisement is distributed, or the like. For example, as illustrated in FIG. 3, text advertisements are classified into categories, such as “car”, “cosmetics”, and “home appliance”.

The “category keyword” is a keyword related to an associated text advertisement, and is information used to select a text advertisement. The category keyword may be set for each category to which an advertisement content belongs, or may be set by an advertiser who submits a text advertisement when the text advertisement is submitted.

The “advertisement copy” is a text advertisement submitted by an advertiser. For example, the example illustrated in FIG. 3 indicates that an advertiser identified by an advertiser ID “CL1” submits an advertisement copy “ooo . . . ” as the text advertisement A01 identified by the text advertisement In “A01”. Furthermore, it is indicated that the text advertisement A01 is an advertisement related to “car” and is an advertisement With a content related to keywords, such as “car, drive, vehicle, travel, holiday, . . . ”.

If each text advertisement is distributed by bidding, the advertisement database 34 may appropriately store information, such as a bid price or a click through rate (CTR). In this case, an advertisement selecting unit 37 to be described later selects a text advertisement to be distributed by using the bid price or the CTR stored in the advertisement database 34 as one index.

Furthermore, if each text advertisement is distributed as an impression-guaranteed type in which the number of impressions is guaranteed, the advertisement database 34 may appropriately store information, such as the number of impressions or the number of guaranteed impressions. In this case, the advertisement selecting unit 37 to be described later selects a text advertisement to be distributed by using the number of impressions and the number of guaranteed impressions as indices, from among the text advertisements stored in the advertisement database 34.

Referring back to FIG. 2, the description is continued. The control unit 33 is controller. The control unit 33 is implemented by, for example, executing various programs stored in an internal storage device of the advertisement distribution server 30 by a central processing unit (CPU), a micro processing unit (MPU), an application specific integrated circuit (ASIC), a field programmable gate array (FPGA), or the like using a TRAM as a work area.

As illustrated in FIG. 2, the control unit 33 includes a submission accepting unit 35, a request accepting unit 36, the advertisement selecting unit 37, and a distributing unit 38, and implements or executes functions and operations of information processing as described below. The internal configuration of the control unit 33 is not limited to the configuration illustrated in FIG. 2, and any other configuration that performs the information processing as described below is applicable. Furthermore, a connection relation between the processing units of the control unit 33 is not limited to the connection relation illustrated in FIG. 2, and any other connection relation is applicable.

The submission accepting unit 35 accepts submission of a text advertisement from an advertiser. Specifically, upon accepting submission of a text advertisement, a category, and a keyword, the submission accepting unit 35 registers various kinds of information, such as the text advertisement, the category, and the keyword accepted above, and an advertiser ID in the advertisement database 34 in an associated manner.

The request accepting unit 36 accepts an acquisition request for an advertisement content from the terminal device 100. For example, the request accepting unit 56 accepts an advertisement request as a request for distribution of a text advertisement.

When the request accepting unit 36 accepts the advertisement request, the advertisement selecting unit 37 selects a text advertisement as a distribution candidate from the advertisement database 34. For example, the advertisement selecting unit 37 performs matching between the keyword transmitted with the advertisement request from the terminal device 100 and a category or keywords of the text advertisement registered in the advertisement database 34. For example, the advertisement selecting unit 37 selects a text advertisement for which the number of keywords that match the keyword transmitted with the advertisement request is the greatest. Consequently, the advertisement selecting unit 37 can select a text advertisement corresponding to an attribute of a user to which the advertisement content is distributed or corresponding to the content of the web page W01 in which the advertisement content is arranged.

If each text advertisement is distributed by bidding, a text advertisement with a high bid price or a high CTR is preferentially selected in the matching. Furthermore, if the text advertisement is distributed as the impression-guaranteed type, a test advertisement is selected, in the matching, such that the number of impressions is greater than the number of guaranteed impressions. The advertisement selecting unit 37 outputs the selected text advertisement to the distributing unit 38.

If the web page W01 is a search page, the advertisement selecting unit 37 may use an advertisement distribution method called search advertising for extracting a text advertisement content that matches a search keyword specified in the search page. Furthermore, the advertisement selecting unit 37 may use an advertisement distribution method called targeted distribution for selecting a text advertisement that matches attribute information (a psychographic attribute, a demographic attribute, or the like) on a user.

The distributing unit 38 distributes, to the advertisement generation server 10, the text advertisement selected by the advertisement selecting unit 37 and the category and the keywords registered in association with the text advertisement. The category and the keywords are used to select an image related to the text advertisement by the image distribution server 40.

4. Configuration of Image Distribution Server

A configuration of the image distribution server 40 according to the embodiment will be described below with reference to FIG. 4. FIG. 4 is a diagram illustrating an example of a functional configuration of the image distribution server according to the embodiment. As illustrated in FIG. 4, the image distribution server 40 includes a communication unit 41, a storage unit 42, and a control unit 43. The communication unit 41 is implemented by, for example, a NIC or the like. The communication unit 41 is connected to the network N by wire or wireless, and performs transmission and reception of information with the terminal device 100 and the advertisement generation server 10.

The storage unit 42 is implemented by, for example, a semiconductor memory device, such as a RAM or a flash memory, or a storage device, such as a hard disk or an optical disk. The storage unit 42 stores therein an image database 44 in which an image to be a distribution target is registered.

In the image database 44, an image, such as an image registered by a provider different from the advertiser who has submitted the text advertisement to the advertisement distribution server 30 or an image automatically collected through the Internet, which is collected and managed independent of a text advertisement is registered. For example, FIG. 5 is a diagram illustrating an example of information registered in the image database according to the embodiment. As illustrated in FIG. 5, the image database 44 includes items such as “image ID”, “image”, and “image keyword”.

The “image ID” is identification information for identifying an image to be a distribution target. The “image” indicates an image to be a distribution target. In the following, the identification information stored in the image ID illustrated in FIG. 5 may be used as a reference symbol of an image. That is, an image identified by an image ID “P01” may be described as the “image P01”.

The “image keyword” indicates a keyword related to an image. The image keyword is set for each image in advance. For example, the image keyword is set by the image distribution server 40 and tagged to each image at a timing at which the image distribution server 40 stores each image. Specifically, in the example illustrated in FIG. 5, an image identified by an image ID “P01” is illustrated. Furthermore, it is indicated that image keywords tagged to the image P01 are, for example, “car, road, highway, drive, sports car, travel, movement, . . . ”.

Data of en image to be actually distributed may be stored in a storage server separated from the image distribution server 40. In this case, the image distribution server 40 specifies an image stored in the external storage server on the basis of the image ID stored in the image database 44. The image distribution server 40 acquires a predetermined image from the storage server when using the predetermined image.

The control unit 43 is implemented by, for example, executing various programs (corresponding to an example of a distribution program) stored in an internal storage device of the image distribution server 40 by a CPU, an MPU, an ASIC, an FPGA or the like using a RAM as a work area. As illustrated in FIG. 4, the control unit 43 includes an image selecting unit 45 and an image distributing unit 46, and implements or executes functions and operations of information processing as described below. The Internal configuration of the control unit 43 is not limited to the configuration illustrated in FIG. 4, and any other configuration that performs the information processing as described below is applicable. Furthermore, a connection relation between the processing units of the control unit 43 is not limited to the connection relation illustrated in FIG. 4, and any other connection relation is applicable.

The image selecting unit 45, upon accepting an image request and a keyword from the advertisement generation server 10, acquires an image corresponding to the accepted keyword from the image database 44. For example, if the keyword includes information such as “car”, “road”, and “drive”, the image selecting unit 45 selects the image P01 associated with an image keyword including many of the keywords. Furthermore, if the keyword includes information such as “music” and “headphone”, the image selecting unit 45 selects the image 202 associated with an image keyword including many of the keywords.

The keyword received with the image request includes a category or a category keyword (hereinafter, described as category information) of a text advertisement distributed by the advertisement distribution server 30, information on the web page W01 viewed by the terminal device 100, an attribute of the user, or the like. Therefore, the image selecting unit 45 can select an image corresponding to the text advertisement distributed by the advertisement distribution server 30, the web page W01, the attribute of the user, or the like. The process of selecting an image performed by the image selecting unit 45 is not limited to the above-described process, and any other arbitrary process is applicable.

The image distributing unit 46 distributes the image selected by the image selecting unit 45 to the advertisement generation server 10.

5. Configuration of Advertisement Generation Server

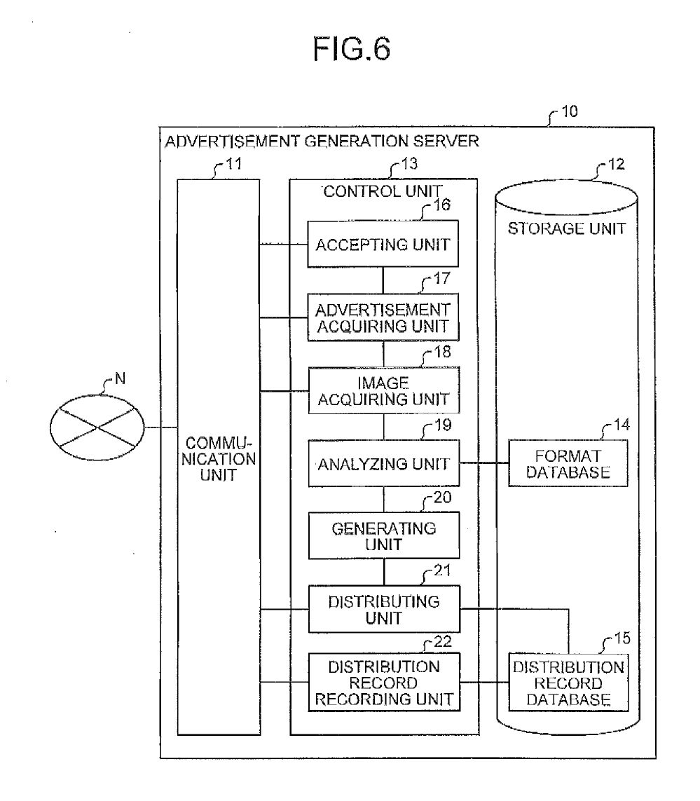

A functional configuration of the advertisement generation server 10 according to the embodiment will be described below with reference to FIG. 6. FIG. 6 is a diagram illustrating an example of the functional configuration of the advertisement generation server according to the embodiment. As illustrated in FIG. 6, the advertisement generation server 10 includes a communication unit 11, a storage unit 12, and a control unit 13. The communication unit 11 is implemented by, for example, a NIC or the like. The communication unit 11 is connected to the network N by wire or wireless, and performs transmission and reception of information with the terminal device 100, the advertisement distribution server 30, and the image distribution server 40.

The storage unit 12 is implemented by, for example, a semiconductor memory device, such as a RAM or a flash memory, or a storage device, such as a hard disk or an optical disk. The storage unit 12 stores therein a format database 14 and a distribution record database 15.

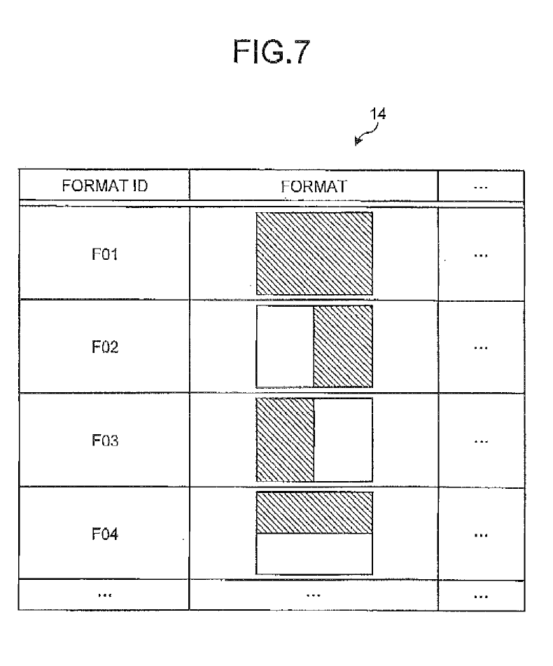

In the format database 14, information indicating how a text advertisement and an image are composited to generate an advertisement content, that is, information indicating a composition mode is registered. For example, FIG. 7 is a diagram illustrating an example of information registered in the format database according to the embodiment. Ps illustrated in FIG. 7, the format database 14 includes items such as “format TD” and “format”.

The “format ID” is identification information for identifying a format. The “format” indicates a position at which the text advertisement is arranged in an image and an area of the image in which the visibility is reduced when an advertisement content is generated. In the following, the identification information stored in the format ID illustrated in FIG. 7 may be used as a reference symbol of a format. That is, a format identified by a format ID “F01” may be described as a “format F01”.

For example, in the example illustrated in FIG. 7, images, which have the same sizes as an image to be distributed and in which areas for reducing the visibilities are indicated by oblique lines, are registered as formats F01 to F04. More specifically, the format F01 indicates that the visibility of the entire image is reduced and a text advertisement is arranged in the entire image. A format 102 indicates that the visibility of the right half area of an image is reduced and a text advertisement is arranged in the right half area. A format F03 indicates that the visibility of the left half area of an image is reduced and a text advertisement is arranged in the left half area. The format F04 indicates that the visibility of the upper half area of an image is reduced and a text advertisement is arranged in the upper half area.

The distribution record database 15 stores therein information on records of advertisement contents distributed to the terminal device 100. Specifically, the distribution record database 15 according to the embodiment stores therein information on a distributed advertisement content, by using a combination of a text advertisement, an image, and a format from which the composition is made.

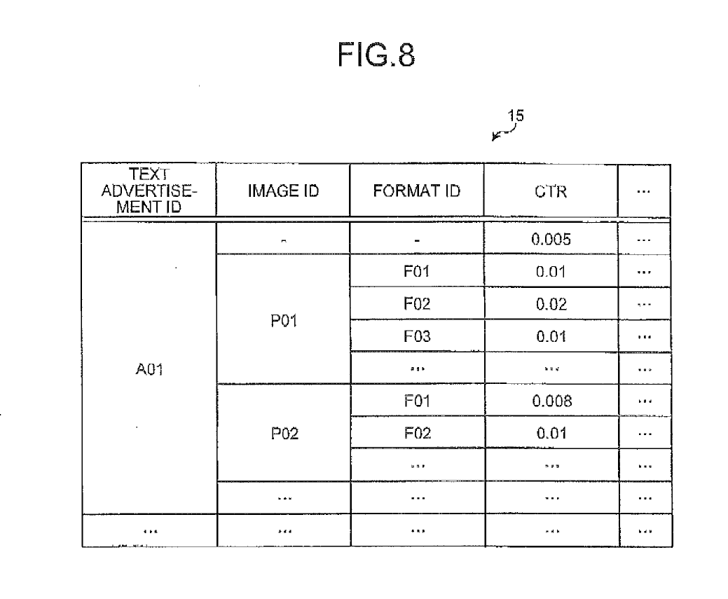

For example, FIG. 8 is a diagram illustrating en example of information registered in the distribution record database according to the embodiment. In the example illustrated in FIG. 8, the distribution record database 15 includes items such as “text advertisement ID”, “image ID”, “format ID”, and “CTR”.

The “text advertisement ID” is identification information for identifying an advertisement content submitted from an advertiser to the advertisement distribution server 30 as described above. The “image ID” is identification information on an image combined with a text advertisement when an advertisement content distributed to the terminal device 100 is generated. The “format ID” is identification information for identifying a format used to generate an advertisement content distributed to the terminal device 100.

The “CTR” indicates a CTR of the advertisement content that is generated by using the text advertisement ID, the image ID, and the format ID associated with one another. For example, in the distribution record database 15, a value, which is obtained by dividing the number of times a user clicks on an advertisement content generated by using the text advertisement ID, the image ID, and the format ID associated with one another by the number of times the advertisement content is displayed, is registered as a CTR. The value of the CTR is used as an index indicating the advertising effect to be achieved when the advertisement content is distributed to the terminal device 100.

For example, in the example illustrated in FIG. 8, the CTR of an advertisement content that is generated with the text advertisement A01 identified by the text advertisement ID “A01” and the image identified by the image ID “P01” in the format indicated by the format ID “F01” is “0.01”. Furthermore, in the example illustrated in FIG. 8, the CTR of an advertisement content that is generated with the text advertisement A01 identified by the text advertisement ID “A01” and the image identified by the image ID “P01” in the format identified by the format ID “F02” is “0.02”. As described above, the advertisement generation server 10 manages the CTR for each combination of the text advertisement, the image, the format used to generate the advertisement content.

While not illustrated in FIG. 8, it may be possible to register, in the distribution record database 15, the number of all distributions of advertisement contents, the number of distributions to each of the terminal devices 100 as distribution targets, or the like for each combination of the text advertisement, the image, and the format. Furthermore, it may be possible to register, in the distribution record database 15, an index indicating the advertising effect other than the CTR. For example, it may be possible to register, in the distribution record database 15, information such as a conversion rate (CVR) indicating a ratio of conversions to the number of times an advertisement content is displayed.

Furthermore, it may be possible to register, in the distribution record database 15, the CTR, the number of distributions, or the like for each text advertisement, for each image, or for each format, in addition to the distribution record for each combination of the text advertisement, the image, and the format. Consequently, the advertisement generation server 10 can extract an image that is likely to be clicked, independent of a specific combination.

Referring back to FIG. 6, the description is continued. The control unit 13 is implemented by, for example, executing various programs (corresponding to an example of. an advertisement generation program) stored in an internal storage device of the advertisement generation server 10 by a CPU, an MPU, an ASIC, an FPGA or the like using a RAM as a work area.

As illustrated in FIG. 6, the control unit 13 according to the embodiment includes an accepting unit 16, an advertisement acquiring unit 17, an image acquiring unit 10, an analyzing unit 19, a generating unit 20, a distributing unit 21, and a distribution record recording unit 22, and implements or executes functions and operations of information processing as described below. The internal configuration of the control unit 13 is not limited to the configuration illustrated in FIG. 6, and any other configuration that performs the information processing as described below is applicable. Furthermore, a connection relation between the processing units of the control unit 13 is not limited to the connection relation illustrated in FIG. 6, and any other connection relation is applicable.

The accepting unit 16 accepts, from the terminal device 100, an advertisement request as a request for a text advertisement to be displayed in the display area of the web page W01 and accepts a keyword. The accepting unit 16 outputs the accepted keyword to the advertisement acquiring unit 17.

The advertisement acquiring unit 17 acquires a text advertisement to be displayed in a display area included in a predetermined content, such as a web page. For example, upon accepting a keyword from the accepting unit 16, the advertisement acquiring unit 17 transmits an advertisement request to request distribution of a text advertisement and the accepted keyword to the advertisement distribution server 30. Consequently, the advertisement acquiring unit 17 acquires a text advertisement, which is selected by the advertisement distribution server 30 on the basis of the keyword, and category information on the text advertisement from the advertisement distribution server 30. Then, the advertisement acquiring unit 17 outputs the keyword accepted from the accepting unit 16, the text advertisement acquired from the advertisement distribution server 30, and the category information on the text advertisement to the image acquiring unit 18.

The image acquiring unit 18 acquires an image provided by a provider different from a provider of the text advertisement. Specifically, upon accepting a keyword, a text advertisement, and category information on the text advertisement from the the advertisement acquiring unit 17, the image acquiring unit 18 transmits an image request to request distribution of an image, the accepted keyword, and the accepted category information on the text advertisement to the image distribution server 40. Consequently, the image acquiring unit 18 acquires an image, which is selected by the image distribution server 40 on the basis of the keyword and the category information on the text advertisement, that is, an image related to the web page W01 displayed by the terminal device 100 or the text advertisement selected by the advertisement distribution server 30. Then, the image acquiring unit 18 outputs the accepted text advertisement and the acquired image to the analyzing unit 19.

Open accepting the text advertisement and the image from the image acquiring unit 18, the analyzing unit 19 analyzes a distribution of a feature amount included in the accepted image, and specifies an area on which the text advertisement is superimposed in the image on the basis of a result of the analysis. For example, the analyzing unit 19 divides the accepted image into a plurality of areas, and extracts a feature amount of each of the divided areas by using a known image analysis method. Furthermore, the analyzing unit 19 specifies a distribution of the feature amount in the entire image on the basis of the feature amount extracted for each area.

The analyzing unit 19 selects a format used to composite a text advertisement and an image from the format database 14 in accordance with the specified distribution of the feature amount. More specifically, the analyzing unit 19 selects a format indicating that the visibility of an area with a smaller extracted feature amount than those of other areas in an image is to be reduced and that a text advertisement is to be arranged in this area. Furthermore, if the feature amount is distributed on average in the entire image, the analyzing unit 19 selects a format indicating that the visibility of the entire image is to be reduced and a text advertisement is to be arranged in the entire image.

For example, in the image P01 illustrated in FIG. 5, a vehicle as an object is arranged in the entire screen, so that it is possible to assume that the feature amount is uniformly distributed in the entire image. Therefore, upon accepting the image P01 from the image acquiring unit 18, the analyzing unit 19 selects the format F01 indicating that the visibility of the entire image is to be reduced and a text advertisement is to be arranged in the entire image.

In the image P02, a main-body part of headphones as an object is arranged in the right half of the image, so that it is possible to assume that the feature amount is biased toward the right side of the image. Therefore, upon accepting the image P02 from the image acquiring unit 18, the analyzing unit 19 selects the format F03 indicating that the visibility of the left half area of the image is to be reduced and a text advertisement is to he arranged on the left half area.

In the image P03, the face of a person as an object is arranged in the left half of the image, so that it is possible to assume that the feature amount is biased toward the left side of the image. Therefore, upon accepting the image P03 from the image acquiring unit 18, the analyzing unit 19 selects the format F02 indicating that the visibility of the right half area of the image is to be reduced and the text advertisement is to be arranged on the right half area.

In the image P04, a a plurality of objects, such as a person and bags, are arranged in the lower half of the image, so that it is possible to assume that the feature amount is biased toward the lower side of the image. Therefore, upon accepting the image Y04 from the image acquiring unit 18, the analyzing unit 19 selects the format P04 indicating that the visibility of the upper half area of the image is to be reduced and the text advertisement is to be arranged on the upper half area.

Upon selecting a format, the analyzing unit 19 outputs the selected format, the accepted image, and the accepted text advertisement to the generating unit 20.

The generating unit 20 generates an advertisement content in which the text advertisement is superimposed on the image such that at least a part of the image is visible, that is, an advertisement content in which the image serves as the background of the text advertisement. Specifically, the generating unit 20 accepts the text advertisement selected by the advertisement distribution server 30, the image selected by the image distribution server 40, and the format selected by the analyzing unit 19. Then, the generating unit 20 generates an advertisement content in which the text advertisement is superimposed on the accepted image in the composition mode indicated by the accepted format.

For example, the generating unit 20 reduces the contrast ratio of the area of the image indicated by the format to below a predetermined value, such as the contrast ratio of the text advertisement, to thereby reduce the visibility of the area relative to the visibility of the text advertisement. Then, the generating unit 20 generates an advertisement content in which the accepted text advertisement is superimposed on the front of the area of the image indicated by the format, that is the area in which the visibility is reduced.

Furthermore, the generating unit 20 sets a link to a landing page in the whole area of the generated advertisement content, and arranges display objects, such as a URL of the link site or “view site”, in the area indicated by the format, that is, the area on which the text advertisement is superimposed. Then, the generating unit 20 outputs the generated advertisement content to the distributing unit 21. Through the process as described above, the generating unit 20 generates an advertisement content such that the visibility of an area with a large feature amount in the image is maintained as it is, such that the visibility of an area with a low feature amount in the image is reduced, and such that the text advertisement is arranged on the front of the area with the reduced visibility.

For example, as illustrated in FIG. 1, if the image distribution server 40 selects the image P01, the analyzing unit 19 selects the format F01. Consequently, the generating unit 20 generates the advertisement content C01, in which the contrast ratio of the entire image P01 is reduced and the text advertisement A01 is superimposed on the entire image P01.

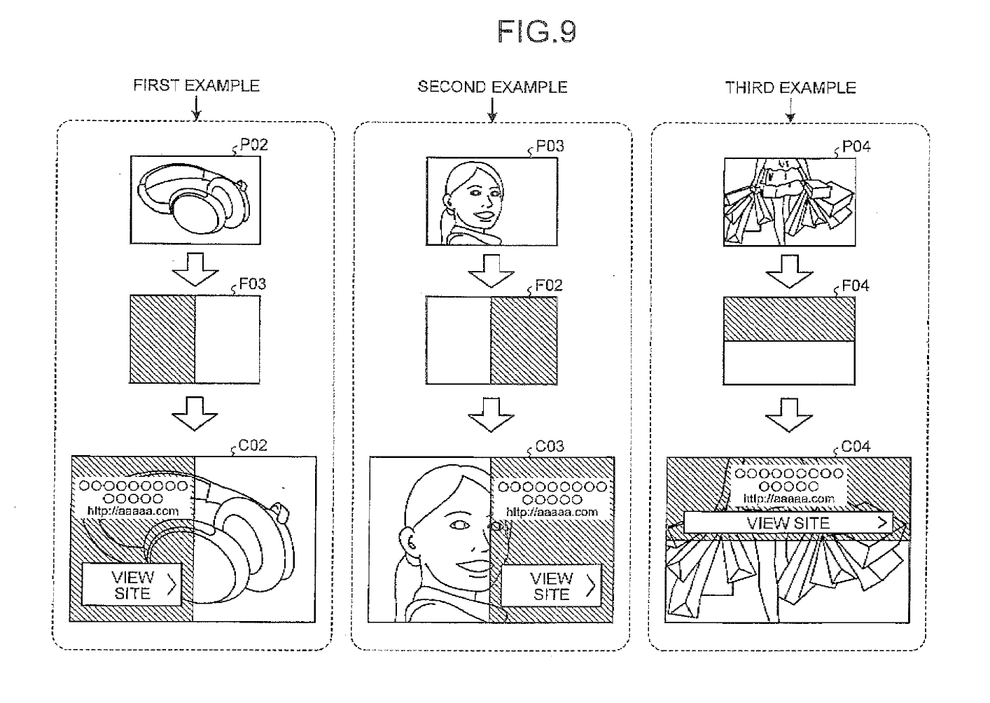

FIG. 9 is a diagram illustrating other examples of the advertisement content generated by the advertisement generation server according to the embodiment. In FIG. 9, a process of generating the advertisement contents C02 to C04 by the advertisement generation server 10 when the image distribution server 40 selects the images P02 to P04 are illustrated as first to third examples.

For example, as illustrated in the first example in FIG. 9, if the image distribution server 40 selects the image P02, the analyzing unit 19 selects the format F03. Consequently, the generating unit 20 generates an advertisement content C02 in which the contrast ratio of the left half of the image P02 is reduced and the text advertisement and display objects, such as a URL and “view site”, are superimposed on the left half of the image P02.

As illustrated in the second example in FIG. 9, if the image distribution server 40 selects the image P03, the analyzing unit 19 selects the format 702. Consequently, the generating unit 20 generates an advertisement content C03 in which the contrast ratio of the right half Of the image P03 is reduced and the text advertisement and display objects, such as a URL and “view site”, are displayed on the right half of the image P03.

As illustrated in the third example in FIG. 9, if the image distribution server 40 selects the image P04, the analyzing unit 19 selects the format T04. Consequently, the generating unit 20 generates an advertisement content C04 in which the contrast ratio of the upper half of the image 204 is reduced and the text advertisement and display objects, such as a URL and “view site”, are displayed on the upper half of the image P04.

Referring back to FIG. 6, the description is continued. The distributing unit 21 distributes the advertisement content generated by the generating unit 20 to the terminal device 100 serving as a request source. Specifically, the distributing unit 21 distributes the advertisement content that is generated by the generating unit a from the text advertisement and the image, to the terminal device 100 that has requested distribution of a text advertisement.

Furthermore, the distributing unit 21 stores information on the distributed advertisement content in the distribution record database 15. Specifically, the distributing unit 21 registers, in the distribution record database 15, the text advertisement ID indicating the text advertisement from which the distributed advertisement content is generated, the image ID of the image from which the distributed advertisement content is generated, and the format ID of the format used to generate the distributed advertisement content, in an associated manner.

The distribution record recording unit 22 acquires evaluation information on evaluation of the distributed advertisement content. Specifically, the distribution record recording unit 22 acquires, as the evaluation information, an index, such as a CTR, indicating the advertising effect on the basis of information on the number of times the advertisement content is distributed, the number of times a user selects the advertisement content distributed to the terminal device 100 (for example, the number of times the user clicks the advertisement content), or the like. The distribution record recording unit 22 registers the acquired evaluation information, such as the CTR, in the distribution record database 15 for each combination of the text advertisement, the image, and the format from which the advertisement content is generated.

The distribution record recording unit 22 may acquire information on benefits that the advertiser of the text advertisement has obtained by displaying a new advertisement content in the advertisement space of the web page W10, in addition to the CTR. Specifically, the distribution record recording unit 22 acquires information related to conversion (CV) indicating whether the user of the terminal device 100 has performed an action that leads to benefits of the advertiser because of the advertisement content distributed from the distributing unit 21 to the terminal device 100. The CV indicates a final result that can be obtained by the advertiser, and corresponds to a user's behavior that benefits the advertiser. Examples of the CV include a behavior of purchasing a product on a web page, a behavior of enrolling as a member, a behavior of requesting a brochure, and a behavior of making inquiries about a product. The CV may include a behavior of purchasing a product, enrolling as a member, requesting a brochure, making inquiries, or the like by an offline method (by phone or mail) without via the web page of the advertiser by the user who has accessed the advertisement content.

Furthermore, the distribution record recording unit 22 may further acquire information on different evaluation if needed. For example, the distribution record recording unit 22 acquires the number of times the advertisement content is actually displayed on the terminal device 100 (the number of impressions) or a display duration. Moreover, the distribution record recording unit 22 acquires information on revenue from advertisement, such as a cost per click (CPC) that is the amount of fee charged for a click on the advertisement content or an effective cost per mill (eCPM) that is the amount of fee charged for a thousand of displays of the advertisement content, and registers the acquired information in the distribution record database 15.

6. Flow of Generation Process

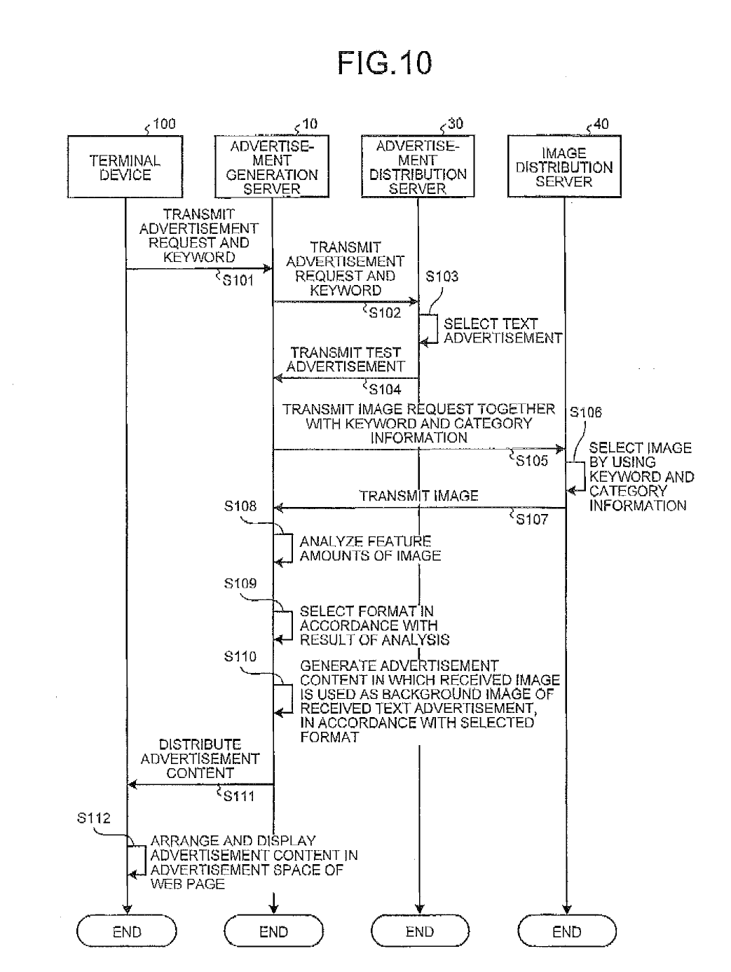

The flow of the generation process performed by the advertisement generation system 1 according to the embodiment will be described below with reference to FIG. 10. FIG. 10 is a sequence diagram illustrating an example of the generation process performed by the advertisement generation system according to the embodiment.

First, the terminal device 100 transmits an advertisement request for a text advertisement and a keyword to the advertisement generation server 10 (Step S101). In this case, the advertisement generation server 10 transmits the advertisement request and the keyword to the advertisement distribution server 30 (Step S102). The advertisement distribution server 30 selects a text advertisement based on the received keyword. (Step S103), and transmits the selected text advertisement to the advertisement generation server 10 (Step S104).

Subsequently, the advertisement generation server 10 transmits en image request together with the keyword and category information on the test advertisement to the image distribution server 40 (Step S105). In this case, the image distribution server 40 selects an image by using the keyword and the category information (Step S106), and transmits the selected image to the advertisement generation server 10 (Step S107).

Subsequently, the advertisement generation server 10 analyzes the feature amount of the received image (Step S108), and selects a format in accordance with a result of the analysis (Step S109). The advertisement generation server 10 generates an advertisement content in which the received image is used as a background image of the text advertisement in accordance with the selected format (Step S110). The advertisement generation server 10 distributes the generated advertisement, content to the terminal device 100 (Step S111). The terminal device 100 displays the advertisement content distributed from the advertisement generation server 10 in the display area included in the web page W01 (Step S112).

7. Flow of Process Performed by Advertisement Generation Server

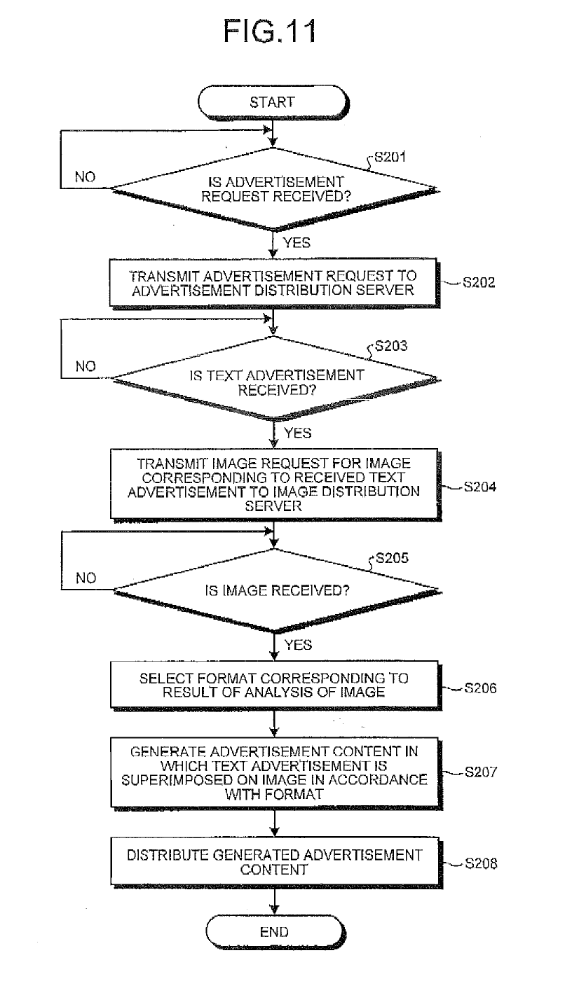

The flaw of the process performed by the advertisement generation server 10 according to the embodiment will be described below with reference to FIG. 11. FIG. 11 is a flowchart illustrating an example of the process performed by the advertisement generation server according to the embodiment.

As illustrated in FIG. 11, the advertisement generation server 10 determines whether an advertisement request is received from the terminal device 100 (Step S201). If the advertisement request is received (YES at Step S201), the advertisement generation server 10 transmits the advertisement request to the advertisement distribution server 30 (Step S202). The advertisement generation server 10 determines whether a text advertisement is received from the advertisement distribution server 30 (Step S203). If the text advertisement is received (YES at Step S203), the advertisement generation server 10 transmits, to the image distribution server 40, an image request to request distribution of an image corresponding to the received text advertisement (Step S204).

Then, the advertisement generation server 10 determines whether the image is received (Step S205). If the image is received (YES at Step S205), the advertisement generation server 10 selects a format corresponding to a result of analysis of the received image (Step S206). Subsequently, the advertisement generation server 10 generates an advertisement content in which the text advertisement is superimposed on the received image in accordance with the selected format (Step S207). Then, the advertisement generation server 10 distributes the generated advertisement content to the terminal device 100 (Step S208), and the process ends.

If the image is not received (NO at Step S205), the advertisement generation server 10 waits until the image is received. If the text advertisement is not received (NO at Step S203), the advertisement generation server 10 waits until the text advertisement is received. If the advertisement request is not received (NO at Step S201), the advertisement generation server 10 waits until the advertisement request is received.

8. Modifications

The advertisement generation server 10 according to the above-described embodiment may be embodied in various different forms other than the above-described embodiment. Other embodiments of the advertisement generation server 10 will be described below.

8-1. Process of Reducing Visibility of Image

In the above-described process, the advertisement generation server 10 reduces the contrast ratio of the image P01 in order to reduce the visibility of the image P01 relative to the visibility of the text advertisement A01. However, the embodiment is not limited to this example. That is, the advertisement generation server 10 may use arbitrary methods as long as the visibility of the background image is reduced relative to the visibility of the text advertisement.

For example, the advertisement generation server 10 may generate the advertisement content C01 by arranging a control image with a predetermined color, such as white or gray, and predetermined transparency in front of the background image in order to reduce the visibility of the background image and by superimposing the text advertisement A01 on the foreground. Furthermore, the advertisement generation server 10 may change the color of the control image in accordance with a color used to display the text advertisement. For example, if the text advertisement is displayed in a black color, the advertisement generation server 10 may arrange a control image colored in white. Furthermore, the advertisement generation server 10 may arrange a control image that is colored in accordance with a color tone of the background image.

Moreover, the advertisement generation server 10 may change the transparency of the control image in accordance with an amount, fineness, a color distribution, or the like of an object pictured in the background image. For example, if the background image is colored in a greater number of colors than a predetermined threshold, the advertisement generation server 10 may reduce the transparency of the control image to below a predetermined threshold. If the background image is colored in a smaller number of colors than a predetermined threshold, the advertisement generation server 10 may increase the transparency of the control image to above a predetermined threshold in order to relatively improve the visibility of the text advertisement.

Furthermore, the advertisement generation server 10 may perform a process of blurring the outline of the background image. For example, the advertisement generation server 10 may perform an image analysis on the background image, and if a difference in the color tone between adjacent pixels is greater than a predetermined threshold, the advertisement generation server 10 may adjust the colors of the pixels such that the amount of difference falls below a predetermined threshold. Through the above-described process, the visibility of the background image is reduced and the visibility of the text advertisement is relatively improved, so that the advertisement generation server 10 can attract the interest of a user in the advertisement content.

Moreover, as long as the visibility of the text advertisement can be improved, the advertisement generation server 10 may perform an image analysis on the background image and apply arbitrary image processing corresponding to a result of the analysis to the background image. Furthermore, the advertisement generation server 10 may apply the above-described various processes to only a part of the area of an image distributed by the image distribution server 40 in accordance with the selected format.

Moreover, the advertisement generation server 10 may reduce the visibility of only a range expanded by a predetermined amount from an area of the background image arranged behind text included in the text advertisement. For example, the advertisement generation server 10 may arrange the control image with a white color and predetermined transparency in an area enclosing text of the text advertisement in the background image, and arrange the advertisement in the whole area of the central image.

Furthermore, if the text advertisement includes a large number of characters, the visibility of the text advertisement may be reduced. Therefore, the advertisement generation server 10 may change the visibility of the background image in accordance with the length of text included in the text advertisement. For example, if the length of text included in the text advertisement is longer than a predetermined threshold, the advertisement generation server 10 may reduce the visibility of the background image to below a predetermined threshold in order to prevent a reduction in the visibility of the text advertisement.

8-2. Visibility of Text Advertisement

The advertisement generation server 10 may increase the visibility of the text advertisement relative to the visibility of the image by changing a color used to display the text advertisement in accordance with the tendency of colors included in an image. For example, if the color tone of the background image is a color, such as black or brown, with low luminosity, the advertisement generation server 10 may generate an advertisement content by superimposing a text advertisement colored in a luminous color, such as white, on the background image. Furthermore, if the text advertisement is to be arranged in the left half area of the image P02, the advertisement generation server 10 may change the color of the text advertisement in accordance with the tendency of colors included in the left half area of the image 202.

Moreover, the advertisement generation server 10 may change the color of the text advertisement in accordance with the tendency of colors included in an image with reduced visibility, or may change the color of the text advertisement in accordance with the color of the control image.

8-3. Text Advertisement and Image

In the above described example, the advertisement generation server 10 generates an advertisement content in which a text advertisement including characters is superimposed on an image. However, the embodiment is not limited to this example. For example, the advertisement generation server 10 may acquire a moving image, and may generate an advertisement content in which a text advertisement is superimposed on the moving image. Furthermore, the advertisement generation server 10 may acquire a foreground content including at least one of text, characters, a graphic, a symbol, an image, and a moving image, and may generate an advertisement content in which the acquired foreground content is superimposed in front of a background content, such as an image or a moving image.

If the foreground content and the background content are superimposed one on top of the other such that the background content is not visible, there is no difference from the mode in which only the foreground content is displayed. Therefore, the advertisement generation server 10 superimposes and displays the foreground content on the background content such that at least a part of the background content is visible. For example, the advertisement generation server 10 performs a process of setting a part of the area of the foreground content as an area in which the background content is transparent, or a process of arranging the foreground content in a part of the area of the background content.

8-4. Image to be Acquired

The above-described advertisement generation server 10 acquires an image related to a text advertisement selected by the advertisement distribution server 30. However, the embodiment is not limited to this example. For example, the advertisement generation server 10 may acquire an image corresponding to a user of the terminal device 100 by transmitting a keyword indicating an attribute, such as gender or age, of the user of the terminal device 100 to the advertisement distribution server 30, and may generate an advertisement content in which the text advertisement is superimposed on the acquired image.

Incidentally, even when the same text advertisement is used, it the text advertisement is combined with a different background image, each combination is recognized as a different advertisement content, and this may attract the interest of a user in the advertisement content. However, it takes time and effort to prepare a plurality of advertisement contents as combinations of the same text advertisement and different background images in advance.

Therefore, when the advertisement generation server 10 distributes the same text advertisement as an advertisement content that has been distributed in the past to the terminal device 100, the advertisement generation server 10 may generate a new advertisement content in combination with an image different from an image used in the already-distributed advertisement content, and may distribute the newly-generated advertisement content. For example, the advertisement generation server 10 registers, in the distribution record database 15, the text advertisement ID of the text advertisement included in the distributed advertisement content and the image ID of the image included in the distributed advertisement content in association with information for identifying the terminal device 100 serving as a distribution destination or in association with information for identifying a user who uses the terminal device 100 (hereinafter, the associated information is described as distribution destination information).

Furthermore, upon receiving an advertisement request from the terminal device 100, the advertisement generation server 10 acquires a text advertisement from the advertisement distribution server 30. Moreover, upon acquiring the text advertisement, the advertisement generation server 10 refers to the distribution record database 15 and specifies an image ID associated with a combination of distribution information indicating a distribution destination to which the advertisement content is newly distributed and the text advertisement ID of the acquired text advertisement. That is, the advertisement generation server 10 specifies an image included in the advertisement content that has been distributed to the distribution destination in the past.

Then, the advertisement generation server 10 transmits the specified image ID to the image distribution server 40, and requests distribution of an image indicated by an image ID different from the specified image ID. That is, the advertisement generation server 10 requests an image different from the image that has been distributed to the distribution destination together with the text advertisement acquired from the advertisement distribution server 30. Upon acquiring an image from the image distribution server 40, the advertisement generation server 10 generates an advertisement content in which the text advertisement is superimposed on the acquired image, and distributes the generated advertisement content to the distribution destination.

As described above, when distributing a text advertisement that has been distributed in the past, the advertisement generation server 10 acquires an image different from an image that has been combined in the past, and distributes an advertisement content in which the text advertisement is superimposed on the acquired image. Consequently, when the advertisement generation server 10 distributes the same text advertisement to the same user for example, the advertisement generation server 10 distributes an advertisement content in which a different image is combined. Therefore, it is possible to provide the advertisement content as if a different advertisement content is displayed even when the same text advertisement is distributed. Thus, the advertisement generation server 10 can attract the interest of the user in the advertisement content. Furthermore, even when an advertiser submits a single text advertisement, the advertisement generation server 10 distributes an advertisement content in which a different image is combined every time the advertisement content is distributed. Consequently, it is possible to reduce time and effort to prepare and submit a plurality of advertisement contents. The advertisement generation server 10 may generate an advertisement content, in which a text advertisement and an image of an already-distributed advertisement content are composited in a format different from a format used in the past distribution. That it is sufficient for the advertisement generation server 10 to generate an advertisement content different from the advertisement content that has been distributed in the past.

8-5. Timing to Acquire Image

In the above-described process, if the advertisement generation server 10 acquires a text advertisement corresponding to the distribution destination information or the information on the web page W01, the advertisement generation server 10 acquires an image corresponding to the acquired text advertisement from the image distribution Server 40. However, the embodiment is not limited to this example. For example, the advertisement generation server 10 may acquire an image corresponding to the distribution destination information or the information on the web page W01, instead of the image corresponding to the text advertisement, and may generate an advertisement content in which the text advertisement is superimposed on the acquired image. In this case, the advertisement generation server 10 may simultaneously transmit the distribution destination information and the information on the web page W01 to the advertisement distribution server 30 and the image distribution server 40, and may simultaneously acquire the text advertisement and the image.

8-6. Mode of Composition of Text Advertisement and Image

The above-described advertisement generation server 10 uses the acquired image as the background image of the text advertisement. However, the embodiment is not limited to this example. For example, the advertisement generation server 10 may use, as the background image of the text advertisement, an image that is cut, reduced, or enlarged in accordance with the size of a display area for displaying the advertisement content. Furthermore, the advertisement generation server 10 may generate an advertisement content in which the acquired image and the text advertisement are arranged side by side in a predetermined range, instead of superimposing the acquired image and the text advertisement. For example, the advertisement generation server 10 may generate an advertisement content in which the image is arranged on the left side of the display area of the web page W01 and the text advertisement is arranged on the right side of the display area.

8-7. Distribution Record to be Recorded

The above-described advertisement generation server 10 records information, such as a CTR, as a distribution record for each combination of the text advertisement, the image, and the format included in the advertisement content. The advertisement generation server 10 may further record information indicating image blurring, the degree of reduction in the contrast ratio of the image, or the like, in an associated manner.

Specifically, even in an advertisement content in which the same text advertisement and the same image are combined, if the detail of editing, such as the degree of blurring of the image, the contrast ratio, the color of the control image, or the transparency of the control image, is changed, a distribution record, such as a CTR, may be changed. Therefore, when the advertisement generation server 10 distributes an advertisement content, the advertisement generation server 10 may register, in the distribution record database 15, the detail of editing applied to an image included in the advertisement content, and may collect a distribution record for each combination of the text advertisement ID, the image ID, and the detail of editing.

Furthermore, when the advertisement generation server 10 generates a new advertisement content, the advertisement generation server 10 analyzes the distribution record database 15 and specifies the detail of editing with which the distribution record, such as a CTR, is expected to be the highest. For example, the advertisement generation server 10 may analyze a CTR associated with a combination of a text advertisement and an image included in a new advertisement content for each detail of editing, and specifies the detail of editing with which the CTR is expected to be the highest. Then, the advertisement generation server 10 may generate an advertisement content by applying the specified detail of editing to the image.

Moreover, the advertisement generation server 10 may analyze the distribution record database 15, learns a combination of a text advertisement and an image with which the CTR is expected to be the highest, and acquires an image corresponding to the text advertisement to be a distribution target in accordance with a result of the learning. Through the above-described process, the advertisement generation server 10 can further improve the appeal effect of the information related to the advertisement content.

8-6. Execution of Generation Process

The advertisement generation server 10 may allow an advertiser to select whether to distribute a submitted text advertisement and an image in a superimposed manner. For example, the advertiser submits whether the advertiser requests distribution of the text advertisement and the image in a superimposed manner. The advertisement generation server 10 specifies whether the advertiser has requested distribution of the text advertisement accepted from the advertisement distribution server 30 and the image in a superimposed manner. The advertisement generation server 10 may perform the above-described generation process when the advertiser has requested distribution of the text advertisement and the image in a superimposed manner, or may distribute the text advertisement as it is without performing the generation process when the advertiser has not requested such distribution.

8-9. Randomness

The advertisement generation server 10 may randomly select an image and a format to be used to generate an advertisement content. Therefore, the advertisement generation server 10 can generate a variety of advertisement contents that do not bore the user even through the generation process based on the same text advertisement.

8-10. Submission of Advertisement

The above-described advertisement generation system 1 may include en advertiser terminal that is an information processing apparatus used by an advertiser and that is used to submit a text advertisement to the advertisement distribution server 30. In some cases, the advertiser may request an agent to submit a text advertisement. In this case, the agent submits the text advertisement to the advertisement distribution server 30. In this document, the “advertiser” is described as a concept including not only the advertiser but also the agent, and the “advertiser terminal” is described as a concept including not only the advertiser terminal but also en agent terminal used by the agent.

8-11. Advertisement Content to be Generated

In the above-described embodiment, an advertisement content in which a text advertisement and an image are superimposed is generated. The advertisement content is not limited to the advertisement content generated in the above-described embodiment. For example, an advertisement content to be generated may be configured such that data, such as a tag, indicating a storage location (for example, a URL) of an image in embedded, instead of a combination of data of the text advertisement and data of the image itself.

In this case, the terminal device 100 acquires the image through the network in accordance with the tag embedded in the distributed advertisement content. Then, the terminal device 100 may generate an advertisement content in which the acquired image is arranged behind the text advertisement included in the advertisement content, and may display the generated advertisement content. In this case, the storage location of the image may be in the image distribution server 40.

Furthermore, in the above-described embodiment, an example has been described in which an advertisement content is generated by using the formats F01 to F04 as illustrated in FIG. 7 as predetermined formats. However, a display mode of the advertisement content to be actually displayed on the terminal device 100 is changed in various ways in accordance with a size of the screen of the terminal device 100, a display size of the advertisement content, a behavior of a web browser of the terminal device 100, enlargement or reduction operation performed by the user, or the like.

8-12. Allocation of Consideration

The above-described advertisement generation server 10 may allocate a part of revenue obtained by distribution of the advertisement content to a provider (for example, a contributor who has contributed an image to the image distribution server 40) of an image included in the distributed advertisement content.

In general, if an advertisement content distributed by the advertisement generation server 10 is displayed on the terminal device 100, if a user clicks the advertisement content, or if the user performs an action such as purchase or request for brochure via the distributed advertisement content, the advertiser pays advertisement fees to an advertisement distributor, such as an administrator of the advertisement generation server 10 or an administrator of the advertisement distribution server 30. Therefore, the advertisement generation server 10 may allocate, as consideration, a part of the advertisement fees paid to the advertisement distributor to the provider of the image.

Furthermore, the advertisement generation server 10 may provide monthly revenue for distribution of images from the image distribution server 40. Moreover, the advertisement generation server 10 may change the amount of revenue to be provided in accordance with a distribution record obtained when each image is used.

The advertisement generation server 10 may allocate a part of the advertisement fees to the provider of the image in accordance with the number of times the advertisement content is clicked or a conversion rate indicating a rate of conversion that the user has performed via the advertisement content. Consequently, the provider of the image can obtain a greater amount of revenue as the provided image is more frequently used so that motivation to provide an image can be increased. Therefore, it is possible to encourage a contributor to contribute an image. ids a result, the advertisement generation server 10 can increase the possibility to generate a variety of advertisement contents or to generate an attractive advertisement content that matches the preference of the user.

8-13. Investigation of Image

If an image keyword irrelevant to an actual image is registered, the advertisement generation server 10 may use an inappropriate image as a background image of a text advertisement to be used as a distribution target. For example, if an image keyword “milk” is associated with an image in which a car is pictured, there is a possibility to generate an advertisement content in which a text advertisement related to “milk” is superimposed on the image of the car.

Therefore, the advertisement generation server 10 may acquire an image subjected to a predetermined investigation from the image distribution server 40. That is, the image distributed by the image distribution server 40 may be limited to an image that is subjected to a predetermined investigation and determined to be appropriate as an image to be included in an advertisement content. Furthermore, an administrator of the image distribution server 40 or the administrator of the advertisement generation server 10 may manually determine an image in which a manufacturer of a product may be specified.

Specifically, the administrator of the image distribution server 40 may visually check an image accepted from an image contributor, and if an associated image keyword is not appropriate, the administrator may perform setting so as not to distribute the accepted image. Furthermore, if the administrator of the image distribution server 40 determines that a manufacturer or the like of a predetermined product may be specified in the image, the administrator may perform setting so as not to provide the accepted image to a third party in order to prevent generation of an advertisement content, in which a text advertisement of a certain product is combined with an image of a product that is the same type of the certain product and that is manufactured by a manufacturer different from a manufacturer related to the text advertisement.

Moreover, if the administrator of the advertisement generation server 10 visually checks an image acquired from the image distribution server 40 and determines that the acquired image is not appropriate as an image to be combined with the advertisement content, the administrator may perform setting so as not to use the acquired image for generating the advertisement content.

The above-described predetermined investigation need not necessarily be performed by the administrator of the image distribution server 40 or the advertisement generation server 10, but may be performed by using, for example, crowdsourcing. Furthermore, the above-described predetermined investigation need not necessarily be performed manually, but may be performed automatically by, for example, the image distribution server 40 or the advertisement generation server 10. Specifically, the image distribution server 40 or the advertisement generation server 10 may determine an appropriate image by using an image recognition technique. For example, the image distribution server 40 or the advertisement generation server 10 may recognize a company logo or a company name included in an image by using the image recognition technique, and may exclude an image from a distribution target when the image includes the company logo or the company name.

8-14. Others

Of the processes described in the embodiment, all or part of a process described as being performed automatically may also be performed manually. Alternatively, all or part of a process described as being performed manually may also be performed automatically by known methods. In addition, the processing procedures, specific names, and information including various kinds of data and parameters illustrated in the above-described document and drawings may be arbitrarily changed unless otherwise specified.

The components of the apparatuses illustrated in the drawings are functionally conceptual and need not necessarily be physically configured in the manner illustrated in the drawings. In other words, specific forms of distribution and integration of the apparatuses are not limited to those illustrated in the drawings, and all or part of the apparatuses may be functionally or physically distributed or integrated in arbitrary units depending on various loads or use conditions.

For example, the format database 14 and the distribution record database 15 illustrated in FIG. 6 may be stored in a storage server or the like, instead of the advertisement generation server 10. In this case, the advertisement generation server 10 acquires a format or a sales record by accessing the storage server.

Furthermore, for example, the above-described advertisement generation server 10 may be distributed into a front-end server side that mainly performs a process with a user, such as acceptance of an advertisement request from the terminal device 100 or distribution of an advertisement content, and a back-end server side that performs the generation process of generating an advertisement content. That is, the advertisement generation server 10 may be an advertisement generation apparatus that performs only the generation process without performing the distribution process of distributing an advertisement content. In this case, the advertisement generation server 10 does not include at least the accepting unit 16 and the distributing unit 21. A predetermined distribution apparatus including the accepting unit 16 and the distributing unit 21 distributes an advertisement content generated by the advertisement generation server 10 to the terminal device 100.

Of the processes described in the embodiment, all or part of a process described as the image extraction process may be applied to a process of selecting and extracting a text advertisement and a format of an advertisement content.

8-15. Hardware Configuration

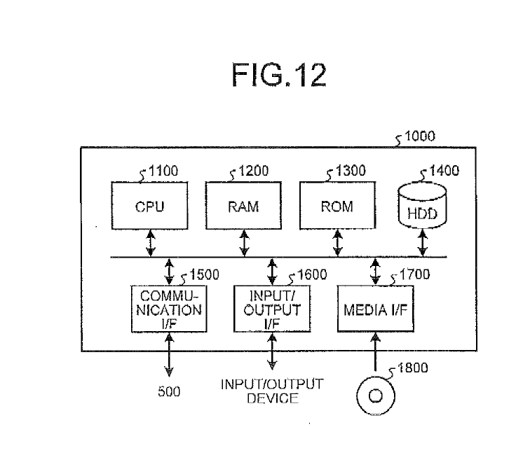

The advertisement generation server 10 according to the above-described embodiment is implemented by, for example, a computer 1000 with a configuration as illustrated in FIG. 12. TIC. 12 is a diagram illustrating an example of a hardware configuration of the computer 1000 that implements the functions of the advertisement generation server. The computer 1000 includes a CPU 1100, a RAM 1200, a ROM 1300, an HDD 1400, a communication interface (I/F) 1500, an input/output I/F 1600, and a media I/F 1700.

The CPU 1100 operates based on a program stored in the ROM 1300 or the HDD 1400, and controls each of units. The ROM 1300 stores therein a boot program executed by the CPU 1100 when the computer 1000 is activated, a program that depends on the hardware of the computer 1000, and the like.

The HDD 1400 stores therein a program executed by the CPU 1100, data used by the program, and the like. The communication I/F 1500 receives data from other devices via a communication network 500 (corresponding to the network N), sends the data to the CPU 1100, and transmits data generated by the CPU 1100 to other devices via the communication network 500.

The CPU 1100 controls an output device, such as a display or a printer, and an input device, such as a keyboard or a mouse, via the input/output I/F 1600. The CPU 1100 acquires data from the input device via the input/output I/F 1600. The CPU 1100 outputs generated data to the output device via the input/output I/F 1600.

The media I/F 1700 reads a program or data stored in a recording medium 1800, and provides the program or the data to the CPU 1100 via the RAM 1200 The CPU 1100 loads the , program onto the RAM 1200 from the recording medium 1800 via the media I/F 1700, and executes the loaded program. The recording medium 1800 may be, for example, an optical recording medium such as a digital versatile disk (DVD) or a phase change rewritable disk (PD), a magneto-optical recording medium such as a magneto-optical disk (MO), a tape medium, a magnetic recording medium, a semiconductor memory, or the like.

For example, when the computer 1000 functions as the advertisement generation server 10, the CPU 1100 of the computer 1000 implements the functions of the control unit 13 by executing the program loaded on the RAM 1200. Furthermore, the HDD 1400 stores therein data stored in the storage unit 12. While the CPU 1100 of the computer 1000 reads the program from the recording medium 1800 and executes the program, the program may be acquired from other devices via the communication network as another example.

9. Effects

As described above, the advertisement generation server 10 acquires a first content (for example, a text advertisement) to be displayed in a display area included in a predetermined content (for example, the web page W01), and a second content (for example, an image) provided by a provider different from a provider of the first content. The advertisement generation server 10 generates a third content (for example, an advertisement content), in which the first content and the second content are superimposed such that at least a part of the second content is visible. Consequently, the advertisement generation server 10 distributes an advertisement content that is more likely to attract attention of a user as compared to the case where a text advertisement is simply distributed for example. Therefore, it is possible to improve the appeal effect of information related to the text advertisement and the advertisement content.

In particular, the disclosed technique is mast suitable when a text advertisement including text related to an advertisement is submitted. For example, it is presumed that a user will be interested in an advertisement content in which an image and text are combined, rather that a text advertisement. However, it takes time and effort to prepare an advertisement content in which an image and text are combined, and if the image is to be changed, it also takes time and effort to newly prepare an advertisement content in which the text and the image are combined although the same tent is used. In contrast, the advertisement generation server 10 automatically generates an advertisement content in which a text advertisement and an image are superimposed. Therefore, it is possible to reduce time and effort to prepare the advertisement content and attract more interest of a user. Consequently, it is possible to improve the appeal effect of the information related to the text advertisement and the advertisement content.

The disclosed technique is useful for distributing an advertisement content when a predetermined application is running or when a user views a moving image, listens music, or views an image, in addition to the case where the web page W01 is displayed.

Furthermore, the advertisement generation server 10 acquires, as the first content, a text advertisement including text to be displayed in the display area. Consequently, the advertisement generation server 10 can improve the appeal effect of the information related to the text advertisement.

Moreover, the advertisement generation server 10 acquires, as the second content, an image or a moving image. Consequently, the advertisement generation server 10 can distribute an advertisement content that attracts more interest of a user as compared to the case where the text advertisement is distributed as it is. Therefore, it is possible to improve the appeal effect of information that is expected to be widely spread to the public by the text advertisement superimposed on the image or the moving image.

Furthermore, the advertisement generation server 10 acquires, as the text advertisement, a text advertisement including information related to the predetermined content, such as the web page W01. Consequently, the advertisement generation server 10 can generate an advertisement content including a text advertisement that fits the content of the web page W01 or the like. Therefore, it is possible to improve the appeal effect of the information related to the advertisement content.

Moreover, the advertisement generation server 10 acquires an image including information related to the text advertisement. Consequently, the advertisement generation server 10 can prevent generation of an advertisement content that includes an image separated from the content of the text advertisement. Therefore, it is possible to improve the appeal effect of the information related to the advertisement content.

Furthermore, when requested to distribute the text advertisement, the advertisement generation server 10 distributes an advertisement content to a request source that has requested the text advertisement. Consequently, the advertisement generation server 10 can improve the appeal effect of the information related to the text advertisement.

Moreover, the advertisement generation server 10 acquires an image corresponding to the request source. Consequently, the advertisement generation server 10 attracts interest of a user to the advertisement content. Therefore, it is possible to improve the appeal effect of the information related to the advertisement content.

Furthermore, when requested to newly distribute a text advertisement by a request source to which the advertisement content has been distributed in the past, the advertisement generation server 10 newly acquires an image different from an image included in the advertisement content that has been distributed to the request source in the past. Then, the advertisement generation server 10 generates a new advertisement content by using the newly-acquired image, and distributes the newly-generated advertisement content. Consequently, even when the same text advertisement is to be distributed for example, the advertisement generation server 10 can distribute an advertisement content in a different mode by combining a different image in each case. Therefore, it is possible to attract the interest of a user in the advertisement content, enabling to improve the appeal effect of the information related to the advertisement content.

Moreover, the advertisement generation server 10 generates an advertisement content in which the text advertisement is superimposed on a part of an area of the image. Consequently, the advertisement generation server 10 can distribute an advertisement content in which the text advertisement and the advertisement content arc superimposed in various modes.

Furthermore, the advertisement generation server 10 analyzes a distribution of a feature amount of the image, specifies an area in which the text advertisement is superimposed in the image in accordance with a result of analysis, and superimposes the text advertisement on the specified area. For example, the advertisement generation server 10 specifies an area with a smaller feature amount than those of other areas in the image, and superimposes the text advertisement on the specified area. Consequently, the advertisement generation server 10 can perform display without disturbing the feature of the image by the text advertisement. Thus, it is possible to improve the appeal effect of information included in the entire advertisement content.

Moreover, the advertisement generation server 10 generates the advertisement content in which the image is arranged behind the text advertisement such that the visibility of the image is reduced relative to the visibility of the text advertisement. For example, the advertisement generation server 10 reduces the contrast ratio of the image relative to the contrast ratio of the text advertisement, to thereby reduce the visibility of the image relative to the visibility of the text advertisement. Furthermore, for another example, the advertisement generation server 10 arranges a control image that is an image with a predetermined color and predetermined transparency behind the text advertisement, and arranges the image behind the control image to reduce the visibility of the image relative to the visibility of the text advertisement.

Furthermore, for another example, the advertisement generation server 10 blurs an outline of an image included in the image in order to reduce the visibility of the image relative to the visibility of the text advertisement. Moreover, for another example, the advertisement generation server 10 changes the color of the text advertisement in accordance with a tendency of colors included in the image in order to reduce the visibility of the image relative to the visibility of the text advertisement. Furthermore, for another example, the advertisement generation server 10 reduces the visibility of an area, on which the text advertisement is superimposed in the image, relative to the text advertisement in order to reduce the visibility of the image relative to the visibility of the text advertisement. Moreover, for another example, the advertisement generation server 10 reduces the visibility of a range expanded by a predetermined amount from an area of the image arranged behind text included in the text advertisement, relative to the text advertisement. Moreover, for another example, the advertisement generation server 10 changes the visibility of the image in accordance with the length of the text included in the text advertisement.

Through the above-described process, even when the text advertisement and the image are superimposed, the advertisement generation server 10 can prevent a reduction in the visibility of the text advertisement included in the advertisement content. Consequently, the advertisement generation server 10 can prevent a reduction in the appeal effect of the information related to the text advertisement.

Furthermore, the advertisement generation server 10 allocates, to a provider who has provided the image included in the advertisement content, a part of revenue obtained by distribution of the advertisement content to the terminal device 100. Consequently, the advertisement generation server 10 can motivate an image contributor to contribute a number of good images. As a result, the advertisement generation server 10 can increase the number of good images available for generation of the advertisement content, so that it is possible to generate an advertisement content that has a better design and that can easily attract the interest of a user.

Moreover, the advertisement generation server 10 acquires an image subjected to a predetermined investigation, consequently, the advertisement generation server 10 generates a new advertisement content by using the image subjected to the investigation. Therefore, it is possible to prevent distribution of an advertisement content in which the text advertisement and the image are composited as an inappropriate combination.

While the embodiments of the present invention have been described above in detail, these embodiments are mere examples, and the disclosed technique may be embodied in various different forms including various modifications or changes based on the knowledge of those skilled in the art, other than the above-described embodiments.

Furthermore, “a unit” recited in the claims may be replaced with “a section, a module, or a means” or “a circuit”. For example, the distributing unit may be replaced with a distributing means or a distributing circuit.

According to an embodiment, it is possible to improve an appeal effect of information related to a content.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A generation apparatus comprising:
an acquiring unit that acquires a first content to be displayed in a display area included in a predetermined content, and a second content that is provided by a provider different from a provider of the first content; and
a generating unit that generates a third content, in which the first content and the second content are superimposed such that at least a part of the second content is visible.

2. The generation apparatus according to claim 1, wherein the acquiring unit acquires, as the first content, a content including text to be displayed in the display area.

3. The generation apparatus according to claim 1, wherein the acquiring unit acquires, as the second content, one of an image and a moving image.

4. The generation apparatus according to claim 1, wherein the acquiring unit acquires, as the first content, a content including information related to the predetermined content.

5. The generation apparatus according to claim 1, wherein the acquiring unit acquires, as the second content, a content including information related to the first content.

6. The generation apparatus according to claim 1, further comprising:
a distributing unit that, when requested to distribute the first content, distributes the third content generated by the generating unit to a request source that has requested the first content.

7. The generation apparatus according to claim 1, wherein the acquiring unit acquires, as the second content, a content including an image corresponding to the request source.

8. The generation apparatus according to claim 6, wherein
when requested to newly distribute the first content by a request source to which the third content has been distributed in the past, the acquiring unit newly acquires a second content including an image different from the second content included in the third content that has been distributed to the request source in the past,
the generating unit generates a new third content by using the second content newly acquired by the acquiring unit, and
the distributing unit distributes the third content that is newly generated by the generating unit.

9. The generation apparatus according to claim 1, wherein the generating unit generates a third content in which the first content is superimposed on a part of an area of the second content.

10. The generation apparatus according to claim 9, wherein the generating unit analyzes a distribution of feature amounts of the second content, specifies an area in which the first content is superimposed in the second content in accordance with a result of analysis, and superimposes the first content on the specified area.

11. The generation apparatus according to claim 10, wherein the generating unit specifies an area with a smaller feature amount than feature amounts of other areas in the second content, and superimposes the first content on the specified area.

12. The generation apparatus according to claim 1, wherein the generating unit generates a third content in which the second content is arranged behind the first content such that visibility of the second content is reduced relative to the visibility of the first content.

13. The generation apparatus according to claim 12, wherein the generating unit reduces a contrast ratio of the second content relative to a contrast ratio of the first content.

14. The generation apparatus according to claim 12, wherein the generating unit arranges an image with a predetermined color and predetermined transparency behind the first content, and arranges the second content behind the image.

15. The generation apparatus according to claim 12, wherein the generating unit blurs an outline of an image included in the second content.

16. The generation apparatus according to claim 12, wherein the generating unit changes a color of the first content in accordance with a tendency of colors included in the second content.

17. The generation apparatus according to claim 12, wherein the generating unit reduces visibility of an area on which the first content is superimposed in the second content, relative to the first content.

18. The generation apparatus according to claim 12, wherein the generating unit reduces visibility of a range expanded by a predetermined amount from an area of the second content arranged behind text included in the first content, relative to the first content.

19. The generation apparatus according to claim 12, wherein the generating unit changes the visibility of the second content in accordance with a length of text included in the first content.

20. The generation apparatus according to claim 1, further comprising:
an allocating unit that allocates, to a provider who has provided the second content, a part of revenue obtained by distribution of the third content generated by the generating unit to a predetermined terminal device.

21. The generation apparatus according to claim 1, wherein the acquiring unit acquires the second content subjected to a predetermined investigation.

22. A generation method implemented by a computer, comprising:
acquiring a first content to be displayed in a display area included in a predetermined content, and a second content that is provided by a provider different from a provider of the first content; and
generating a third content, in which the first content and the second content are superimposed such that at least a part of the second content is visible.

23. A non-transitory computer readable storage medium having stored therein a generation program causing a computer to execute a process comprising:
acquiring a first content to be displayed in a display area included in a predetermined content, and a second content that is provided by a provider different from a provider of the first content; and
generating a third content, in which the first content and the second content are superimposed such that at least a part of the second content is visible.
